(19) United States
(12) Patent Application Publication
(10) Pub. No.: US 2002/0107142 A1
(43) Pub. Date: Aug. 8, 2002

(54) Titania-based porous substance and catalyst

(75) Inventors: Kiyoshi Yamazaki, Aichi-gun (JP); Miho Hatanaka, Aichi-gun (JP); Akihiko Suda, Aichi-gun (JP); Masayuki Fukui, Aichi-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOYOTA CHUO KENKYUSHO, Aichi-gun (JP)

(21) Appl. No.: 09/993,674

(22) Filed: Nov. 27, 2001

(30) Foreign Application Priority Data
Dec. 1, 2000 (JP) 2000-366939

(51) Int. Cl. B01J 21/06

(52) U.S. Cl. 502/339; 502/350

(57) ABSTRACT

A titania-based porous substance includes titania as a principal ingredient, and exhibits an x-ray diffraction peak resulting from lattice planes whose spacing falls in a range of 0.290±0.002 nm. Thus, it includes crystals other than the anatase phase crystal. Therefore, a large number of crystal planes exist therein. As a result, when a catalytic ingredient is loaded on it, the catalytic ingredient is loaded with a lowered rate within the identical crystal plane.

### BACKGROUND OF THE INVENTION

2. Field of the Invention

The present invention relates to a titania-based porous substance in which titania is a principal ingredient, and a catalyst in which the titania-based porous substance makes a support. The titania-based porous substance according to the present invention is extremely useful for a catalytic support, an adsorption agent, a filter, or the like. Moreover, the catalyst according to the present invention, for example, exhibits a high CO shift reactivity from a low temperature range, and can carry out removing CO and generating H₂ with high efficiencies.

2. Description of the Related Art

A titania powder has been utilized widely not only as pigments but also as a raw material for catalytic supports, deodorizing agents, electronic ceramics, and the like. As for the production process, the sulfur method and the chlorine method are the representative ones. In addition thereto, the chemical vapor-phase epitaxy method, etc., have been known.

However, by the conventional production processes which are carried out in a liquid phase, the resulting titania particles agglomerate, and the particles also grow when they are calcined at a high temperature. Accordingly, it has been difficult to produce super fine particulate titania.

Hence, in Japanese Unexamined Patent Publication (KOKAI) No. 6-340,421, there is disclosed an acicular porous fine particulate titanium oxide, which is obtained by a unique production process. The titanium oxide is characterized in that it has an average minor diameter of from 8 to 12 nm, an average major diameter of from 24 to 50 nm and an aspect ratio of from 2.4 to 6.4. Since the titanium oxide is porous, it is expected to be utilized as cosmetics, and so on, by filling perfumes, anti-inflammation substances, etc., in the pores.

While, the CO shift reaction has been applied to the synthesis of ammonium, to the removal of CO from a public utility gas, to the methanol synthesis, to the CO/H₂ ratio adjustment in the oxyo synthesis, or the like. Recently, the CO shift reaction has been also used in the removal of CO in a fuel reforming system of an internally reforming type fuel cell, etc. As set forth in equation (1) below, the CO shift reaction is a reaction in which H₂ is generated from CO and H₂O, and is referred to as a water-gas shift reaction as well.

CO+H₂O→CO₂+H₂ (1)

As for a catalyst which facilitates the CO shift reaction, for example, Cu—Zn-based catalysts were put into markets by Girdler Co., Ltd. and du Pont Co., Ltd. in 1960's, and have been utilized widely so far mainly for applications in plants in production industries. Moreover, in W. Hongli et al., China-Jpn.-U.S. Symp. Hetero. Catal. Relat. Energy Probl., B09C, 213 (1982), there is reported a catalyst which exhibits a much higher CO shift reactivity. The catalyst is prepared by processing a catalyst, in which Pt is loaded on a support being composed of an anatase type titania, by reduction at around 500° C.

Moreover, it has been known a catalyst, in which a noble metal, such as Pt, Rh and Pd, is loaded on γ-Al₂O₃, exhibits a CO shift reactivity as well. However, it has been also reported that a catalyst, in which a noble metal, such as Pt, Rh and Pd, is loaded on γ-Al₂O₃, exhibits a lower CO shift reactivity than a catalyst, in which Cu is loaded on γ-Al₂O₃, does.

However, in a case where the titania, disclosed in Japanese Unexamined Patent Publication (KOKAI) No. 6-340,421, is used as a support and a catalyst is prepared by loading a catalytic ingredient thereon, the catalytic ingredient is loaded along the longitudinal direction of the acicular crystal even if the catalytic ingredient is loaded in a highly dispersed manner. Therefore, since the catalytic ingredient is loaded within the identical crystal plane with a higher rate, there arises a problem in that the catalytic ingredient is likely to agglomerate at an elevated temperature.

While, in the CO shift reaction catalyst, which is used in a fuel reforming system of an internally reforming type fuel cell being boarded in a mobile body, such as an automobile, or which is used in an exhaust gas purifying system for reforming CO, contained in an automotive exhaust gas, into H₂, and reducing NOₓ, being stored on the catalyst, by using the resulting H₂, the catalyst is required to exhibit a high activity under the reaction condition of a large space velocity, because the catalytic reactor is limited in terms of the size.

However,the conventional Cu—Zn-based catalysts suffer from a drawback in that they exhibit a low activity under the reaction condition of a large space velocity. Accordingly, under the reaction condition of a large space velocity, for example, in a fuel reforming system of an internally reforming type fuel cell or in an automotive exhaust gas purifying system, it is difficult for the conventional Cu—Zn-based catalysts to efficiently convert CO into H₂.

Further, since the reaction set forth in equation (1) is an equilibrium reaction, the higher the reaction temperature is the more mainly the reaction, which proceeds in the reverse direction to the arrow specified in equation (1), takes place. Accordingly, it is disadvantageous for the conversion from CO to H₂. Therefore, even when the reaction temperature is heightened in order to compensate for the lowered activity under the condition of a large space velocity, it is difficult for the conventional Cu—Zn-based catalysts to efficiently convert CO into H₂.

Furthermore, when the conventional CO shift reaction catalysts are used in a fuel reforming system of an internally reforming type fuel cell or in an automotive exhaust gas purifying system, there arises a case where the reaction field is temporarily turned into a high temperature atmosphere under certain service conditions. Hence, the conventional CO shift reaction catalysts suffer from the following problem. For example, Cu, the active species of the conventional Cu—Zn-based catalysts, or Cu, which is loaded on the γ-Al₂O₃ of the catalyst, readily causes the granular growth to degrade the activity. Thus, it is more difficult for the conventional CO shift reaction catalyst to efficiently convert CO into H₂.

Moreover,when the conventional CO shift reaction catalysts are used in the reaction set forth in equation (1), the higher the concentration of H₂O is the more likely the reaction proceeds to generate H₂. Therefore, the conventional Cu—Zn-based catalysts are usually used under the condition that the molar H₂O/CO ratio is 2 or more.

However, in order to carry out the reaction set forth in equation (1) by using the conventional Cu—Zn-based catalysts in a confined environment like automobile, it is necessary to prepare a water tank, which can preserve a large amount of water, and a large-sized evaporator. Accordingly, there arises a problem in that such a system enlarges. Moreover, in order to supply a water vapor, a large quantity of energy is required to evaporate water. Consequently, the energy efficiency deteriorates in view of such a system as a whole. Therefore, it is desirable to carry out the reaction by using a water vapor in an amount as small as possible. However, when the molar H₂O/CO ratio is decreased, the conventional CO shift reaction catalysts exhibit such a degraded CO shift reactivity in the reaction that H₂ is produced in an amount of the equilibrium value or less.

Hence, it is possible to think of using a noble metal, which is expected to exhibit higher activities than base metals and to be stable in a high temperature atmosphere. However, as earlier described, the catalyst, in which a noble metal, such as Pt, Rh and Pd, is loaded on γ-Al₂O₃, exhibits a lower activity than the catalyst, in which Cu is loaded on γ-Al₂O₃. Moreover, in a catalyst in which Pt is loaded on a support being composed of the anatase type titania, it has been known that a strong interactive action (i.e., SMSI: Strong Metal-Support Interaction) arises between the Pt and the support. Thus, when such a catalyst is exposed to a reactive gas in a temperature range of from 200 to 400° C., which is involved in the ordinary service conditions, a part of the support ingredient comes to cover the Pt by SMSI so that the number of the active sites decreases. As a result, there arises a drawback in that the activities of the catalyst lower sharply.

### SUMMARY OF THE INVENTION

The present invention has been developed in view of the aforementioned circumstances. It is an object of the present invention to provide a titania-based porous substance whose selectivity and separation performance are improved by its own special pore structure, and on which a catalytic ingredient is inhibited from agglomerating.

Moreover, it is another object of the present invention to make a catalyst, which exhibits a high CO shift reactivity from a low temperature region, from the aforementioned titania-based porous substance.

A titania-based porous substance according to the present invention, which can achieve the aforementioned object, is characterized in that it is a porous substance comprising titania as a principal ingredient and exhibiting an x-ray diffraction peak resulting from lattice planes whose spacing falls in a range of 0.290±0.002 nm. The present titania-based porous substance can preferably exhibit x-ray diffraction peaks resulting from lattice planes whose spacing falls in a range of 0.213±0.002 nm and lattice planes whose spacing falls in a range of 0.144±0.002 nm. Further, the x-ray diffraction peak, resulting from lattice planes whose spacing falls in a range of 0.290±0.002 nm, can preferably exhibit an intensity of 0.1% or more of an intensity of the strongest diffraction peak which derives from the anatase phase. Furthermore, the aforementioned x-ray diffraction peak can preferably derive from the brookite phase.

Further, another titania-based porous substance according to the present invention is characterized in that it is a porous substance comprising titania as a principal ingredient and having a median pore diameter which falls in a meso-pore range of from 3 to 100 nm. Furthermore, in the present titania-based porous substance, 50% or more of the summed volume of pores, whose pore diameters fall in the meso-pore range, can preferably occupy the summed volume of pores, whose pore diameters fall within a range of ±5 nm of the aforementioned median pore diameter. Moreover, 40% or more of the summed volume of pores, whose pore diameters fall in the meso-pore range, can further preferably occupy the summed volume of pores, whose pore diameters fall within a range of ±3 nm of the aforementioned median pore diameter.

In addition, a catalyst according to the present invention is characterized in that a noble metal is loaded on either one of the aforementioned titania-based porous substances. The noble metal can preferably include platinum at least.

Thus, in accordance with an aspect of the present invention, since the present titania-based porous substance exhibits the x-ray diffraction peak resulting from lattice planes whose spacing falls in a range of 0.290±0.002 nm, it includes crystals other than the anatase phase crystal. Therefore, in the present titania-based porous substance, a large number of crystal planes exist so that a catalytic ingredient is loaded with a lowered rate within the identical crystal plane. Hence, the catalytic ingredient is inhibited from agglomerating. As a result, the present catalyst is kept from exhibiting degraded activities even after it is subjected to a durability test.

Moreover, since the present titania-based porous substance has a median pore diameter which falls in the meso-pore range and exhibits a sharp pore diameter distribution, molecules can interact with each other highly frequently therein. Accordingly, the present titania-based porous substance is extremely useful as a reaction field to which molecules contribute. Therefore, in accordance with an aspect of the present invention, the present catalyst is good in terms of the H₂O adsorption ability. At the same time, since there exists CO which is weakly adsorbed onto the catalytic ingredient, the present catalyst exhibits a high CO shift reactivity from a low temperature region.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure:

FIG. 1 illustrates x-ray diffraction patterns which were exhibited by titania porous substances of Example Nos. 1 and 2 as well as Comparative Example No. 1;

FIG. 2 is a graph for illustrating H₂O adsorptions which were exhibited by titania porous substances of Example Nos. 1 and 2 as well as Comparative Example No. 1;

FIG. 3 illustrates infrared (i.e., IR) spectra of CO which was adsorbed onto catalysts of Example No. 3 as well as Comparative Example Nos. 2 and 3; and

FIG. 4 is a graph for illustrating relationships between temperatures and CO conversions, relationships which were exhibited by catalysts of Example Nos. 3 and 4 as well as Comparative Example Nos. 2 through 4.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

In the catalyst in which Pt is loaded on a support comprising the conventional anatase type titania, a strong SMSI arises between the Pt and the support. Accordingly, when the catalyst is exposed to a reactive gas at a temperature of from 200 to 400° C., a part of the support ingredient comes to cover the Pt. There arises a drawback in that the activities of the catalyst have been degraded sharply by the reduction of active sites.

On the other hand, the present titania-based porous substance exhibits an x-ray diffraction peak resulting from lattice planes whose spacing falls in a range of 0.290±0.002 nm. Further, the present titania-based porous substance can preferably exhibit x-ray diffraction peaks resulting from lattice planes whose spacing falls in a range of 0.213±0.002 nm and lattice planes whose spacing falls in a range of 0.144±0.002 nm. Furthermore, at least one of the x-ray diffraction peaks can preferably involve those deriving from the brookite phase. Specifically, in the present titania-based porous substance, crystals other than the anatase phase crystal are put in a state that they are highly dispersed. Accordingly, a large number of crystal planes exist therein so that a catalytic ingredient is loaded with a lowered rate within the identical plane. Hence, in the present catalyst, the catalytic ingredient is inhibited from agglomerating. Moreover, due to the presence of crystals other than the anatase phase crystal, the crystals are prohibited from varying their configurations at an elevated temperature. As a result, the present catalyst is kept from being covered with a part of the support ingredient so that it is inhibited from exhibiting degraded activities.

Further, in the present titania-based porous substance, the x-ray diffraction peak, resulting from lattice planes whose spacing falls in a range of 0.290±0.002 nm, can preferably exhibit an intensity of 0.1% or more of an intensity of the strongest diffraction peak which derives from the anatase phase. With such an arrangement, the aforementioned operations work more effectively so that it is possible to furthermore inhibit the present catalyst from exhibiting degraded activities.

Furthermore, in another aspect of the present invention, the present titania-based porous substance has a median pore diameter which falls in a meso-pore range of from 3 to 100 nm. In the pores of the meso-pore diameter range, the Knudsen diffusion is the mainstream in which molecules move while colliding with the pore walls when they diffuse in the pores. In this case, special phenomena, such as the multi-adsorption and the capillary condensation, take place so that molecules interact with each other highly frequently. Accordingly, the present titania-based porous substance is extremely useful for reactions to which molecules contribute.

Note that, according to the IUPAC (i.e., International Union of Pure and Applied Chemistry) rule, the meso-pore refers to pores which have a diameter of from 2 to 50 nm. In certain cases, however, in view of the adsorption characteristic to molecules, the meso-pore means pores which have a diameter of from 1.5 to 100 nm. In the present invention, the meso-pore shall mean pores which have a diameter of from 3 nm, a lower limit value being measurable with a mercury porosimeter in principle, to 100 nm.

The present titania-based porous substance can include titania as a principal ingredient. In the present invention, however, note that mixing or compositing titania with the other oxides, such as alumina, silica, zirconia, etc., is not excluded at all.

Then, in the present catalyst in which a noble metal is loaded on the present titania-based porous substance, the special phenomena, such as the multi-adsorption of H₂O molecules and the capillary condensation thereof, take place, the H₂O adsorption enlarges. In addition, a furthermore enlargement action of the H₂O adsorption is effected by the interaction of H₂O molecules with the superficial hydroxide groups which are present in a large quantity in the meso-pores. Thus, H₂O molecules interact with the other reactants highly frequently. Therefore, it is possible to make the present catalyst exhibit a higher CO shift reactivity.

Further, depending on the acidity of titania, the superficial hydroxide groups in the meso-pores are acidic. Accordingly, a noble metal, which is loaded in the meso-pores, is turned into a highly oxidized state by being subjected to the electron-withdrawing action of the acidic superficial hydroxide groups. Thus, CO comes to weakly adsorb onto the noble metal. Therefore, it is possible to relieve the self-poisoning in which CO adsorbs strongly onto a noble metal to poison the noble metal. Accordingly, the present catalyst can exhibit upgraded low temperature activities in the CO shift reaction, the CO oxidation reaction, the NOₓ reduction reaction by CO, and the like.

Therefore, in accordance with the present catalyst, a large number of H₂O molecules can exist in the meso-pores, and, at the same time, CO molecules, which adsorb weakly onto the noble metal, can exist therein. Consequently, the present catalyst exhibits a high CO shift reactivity from a low temperature region, which is advantageous from the viewpoint of the equilibrium law. Thus, it is possible to carry out the CO removal and the H₂ generation with high efficiencies.

Moreover, in the present titania-based porous substance, 50% or more of the summed volume of pores, whose pore diameters fall in the meso-pore range, can preferably occupy the summed volume of pores, whose pore diameters fall within a range of ±5 nm of the median pore diameter. In addition, 40% or more of the summed volume of pores, whose pore diameters fall in the meso-pore range, can further preferably occupy the summed volume of pores, whose pore diameters fall within a range of ±3 nm of the median pore diameter. When the present titania-based porous substance exhibits such a sharp meso-pore diameter distribution, it reveals a configuration selectivity which results from the pore diameters. Accordingly, when the present titania-based porous substance is used as an adsorption agent, a filter, or the like, the resulting product is improved in terms of the selectivity or separation performance.

As for the noble metal in the present catalyst, it is possible to utilize Pt, Pd, Rh, Ru, or the like. Among them, the present catalyst can preferably include Pt, which exhibits a high CO shift reactivity. The loading amount of the noble metal can preferably fall in a range of from 0.05 to 30 parts by weight with respect to 100 parts by weight of the support. When the loading amount is less than 0.05 parts by weight with respect thereto, the resulting catalyst might not fully reveal the advantage of igniting CO at a low temperature and the water-gas shift reactivity. When the loading amount is more than 30 parts by weight with respect thereto, there might arise a case where the noble metal clogs the meso-pores, or the resulting catalyst might not fully reveal the advantage of inhibiting the noble metal from sintering.

It is possible to produce the present titania-based porous substance in the following manner. For example, firstly, a raw material solution is prepared which is turned into titania-based oxides by thermal decomposition. Secondly, deposits of oxide precursors are precipitated from the raw material solution. Thirdly, the resulting deposits are aged by holding them at a temperature of room temperature or more. Subsequently, the resulting oxide precursors are calcined to produce the present titania-based porous substance.

As for the raw material solution which is turned into titania-based oxides, it is possible to use an aqueous solution or an alcohol solution, including water, in which titanium trichloride, titanyl sulfate, or the like, is solved. Moreover, the step of precipitating deposits of oxide precursors can be carried out while adjusting a pH of the raw material solution by adding an alkaline solution, like ammonia water, etc., to the raw material solution. In addition to ammonia water, it is possible to use an aqueous solution or an alcohol solution in which ammonium carbonate, sodium hydroxide, potassium hydroxide, sodium carbonate, or the like, is solved. Ammonium water or an ammonium carbonate solution, which evaporates in the calcining step, is especially preferable. Note that a pH of the alkaline solution can preferably be 9 or more. When such is the case, it is possible to facilitate the precipitation reaction of oxide precursors.

In the aging step, the solving and re-precipitating of oxide precursors can be facilitated by heating, and, at the same time, the granular growth of oxide precursors takes place. The aging step can be carried out by holding the deposits of oxide precursors at room temperature or more, further preferably in a temperature range of from 100 to 200° C., furthermore preferably in a temperature range of from 100 to 150° C. in an atmosphere of an saturated vapor, or in an atmosphere close to a saturated vapor, for a predetermined period of time. When the deposits are heated at a temperature of less than 100° C., the facilitation is effected less in the aging and it takes a longer time for aging the deposits. When the deposits are heated at a temperature of higher than 200° C., it is necessary to prepare a large-scale apparatus which can endure a high pressure because the vapor pressure becomes extremely high. Thus, such heating is not preferable because the production cost goes up sharply. Then, by calcining the resulting deposits, it is possible to produce the present titania-based porous substance which is of relatively high crystallinity, which has a median diameter falling in the meso-pore range and x-ray diffraction peak which results from crystal planes whose spacing falls in a range of 0.290±0.002 nm.

The calcining step can be carried out in air. The calcining temperature can preferably fall in a range of from 300 to 900° C. When the calcining temperature is less than 300° C., the resulting titania-based porous substance might virtually lack the stability when it is used as a support for catalysts. When the calcining temperature is more than 900° C., such calcining might result in lowering the specific surface area of the resulting titania-based porous substance. Such high temperature calcining is not required in view of utilizing the present titania-based porous as a support for catalysts.

Note that, when the raw material solution, in which the deposits are precipitated, is heated as it is to evaporate and dry, and when the deposits are further calcined, it is possible to carry out the aging step simultaneously with the evaporating and drying. However, it is preferable to hold and age the raw material solution, which contains the deposits and water, at room temperature or more, preferably at 100° C. or more. Moreover, the deposits can be calcined after they are washed. Note that, however, when the deposits are calcined without carrying out washing, it is possible to produce the present titania-based porous substance which exhibits a much larger x-ray diffraction peak resulting from crystal planes whose spacing falls in a range of 0.290±0.002 nm.

In addition, note that an aspect ratio of the present titania-based porous substance is not limited in particular. However, the aspect ratio can preferably fall in a range of 3 or less. A titania-based porous substance, which is produced by the above-described production process, can not only satisfy the requirements of the present titania-based porous substance but also exhibit an aspect ratio of 3 or less.

The present invention will be hereinafter described in detail with reference to examples and comparative examples.

### EXAMPLE NO. 1

0.3 mol of titanium tetrachloride was solved in 1,000 ml of ion-exchange water. To the resulting solution, 81.6 g of 25% ammonium water was added to precipitate deposits. Subsequently, an aging step was carried out in which the solution, containing the deposits, was held under 2 atm at 120° C. for 2 hours. Thereafter, the deposits were dried, and were calcined in air at 600° C. for 5 hours.

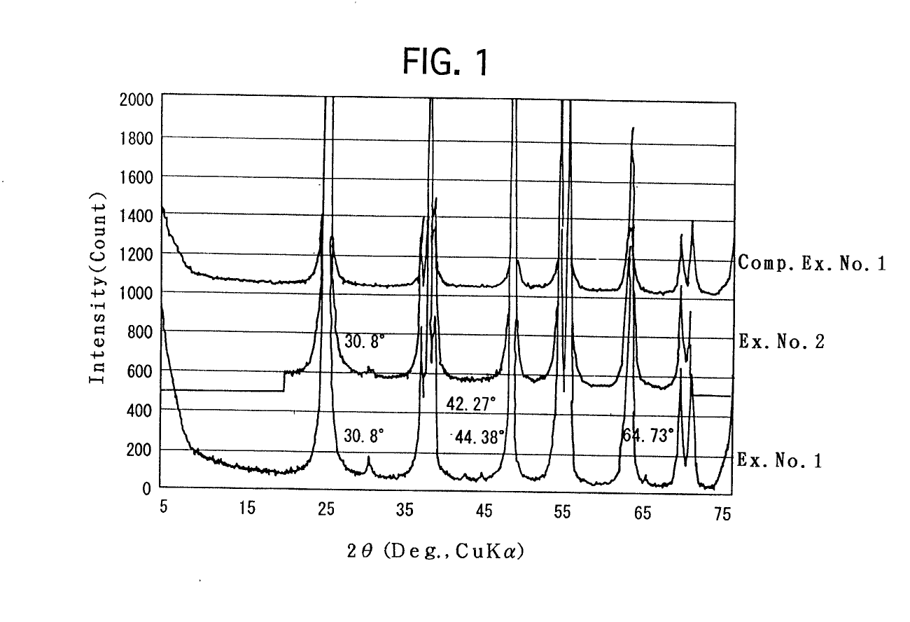

Table 1 sets forth a median pore diameter, a ratio occupied by a summed volume of pores falling within a range of ±5 nm of the median pore diameter, a ratio occupied by a summed volume of pores falling within a range of ±3 nm of the median pore diameter and a BET specific surface area of the resulting titania porous substance. The measurements were carried out with a mercury porosimeter. According to the result of an observation with a TEM (i.e., Transmission Electron Microscope), it was found out that particles, which had an aspect ratio of 2.3 or less, were sparsely agglomerated to form the meso-pores. Moreover, a powder x-ray diffraction analysis was carried out. FIG. 1 illustrates the resulting diffraction pattern.

### EXAMPLE NO. 2

Deposits were precipitated in the same manner as Example No. 1. The aging step was similarly carried out. Thereafter, stirring and filtering were repeatedly carried out by using ion-exchange water to wash the deposits. The resulting deposits were dried, and were calcined in the same manner as Example No. 1. The resulting titania porous substance was subjected to the measurements, observation and analysis in the same manner as Example No. 1. The respective resulting values, etc., are set forth in Table 1 or illustrated in FIG. 1.

Note that, according to the result of the TEM observation, particles, which had an aspect ratio of 2.3 or less, were sparsely agglomerated to form the meso-pores in the titania porous substance of Example No. 2 as well.

### Comparative Example No. 1

A commercially available anatase type titania was used to make a titania porous substance of Comparative Example No. 1. The commercially available anatase type titania was produced by Ishihara Sangyo Co., Ltd. The titania porous substance was subjected to the measurements, observation and analysis in the same manner as Example No. 1. The respective resulting values, etc., are set forth in Table 1 or illustrated in FIG. 1. Note that macro-pores, which had a median pore diameter of 160 nm, were also observed in Comparative Example No. 1.

TABLE 1

| | Characteristics of Pores | | | | Characteristics of Poruous Substances | |
|---|---|---|---|---|---|---|
| | P. C. (*1) | M. P. D. (*2) | ± 5 nm (*3) | ± 3 nm (*4) | S. S. A. (*5) | D. I. R. (*6) |
| Ex. #1 | With Washing | 17.6 nm | 87.2% | 76.5% | 55 m²/g | 2.1% |
| Ex. #2 | W/O Washing | 12.1 nm | 73.2% | 62.7% | 50 m²/g | 1.1% |
| Comp. Ex. #1 | N. A. (*7) | 18.7 nm & 160 nm | 39.6% | 29.9% | 72 m²/g | None |

Notes:
(*1) means “Preparing Condition.”
(*2) means “Median Pore Diameter.”
(*3) means “Ratio Occupied by Summed Volume of Meso-pores Falling within Range of ±5 nm of Median Pore Diameter.”
(*4) means “Ratio Occupied by Summed Volume of Meso-pores Falling within Range of ±3 nm of Median Pore Diameter.”
(*5) means “Specific Surface Area.”
(*6) means “Diffraction Intensity Ratio (i.e., Ratio of Intensity of Diffraction Peak Resulting from Crystal
Lattice Planes whose Spacing Falls in Range of from 0.289 to 0.291 nm with respect to Intenstiy of Strongest Peak Deriving from Anatase Phase.)”
*7) means “Not Applicable.”

### Evaluation

Following can be understood from Table 1. In the titania porous substances of the Example Nos. 1 and 2, 70% or more of the summed volume of pores, whose diameters fell in the meso-pore range, occupied the summed volume of pores, whose diameters fell in a range of ±5 nm of the median pore diameter, and 60% or more of the summed volume of pores, whose diameters fell in the meso-pore range, occupied the summed volume of pores, whose diameters fell in a range of ±3 nm of the median pore diameter. Accordingly, the titania porous substances of the respective examples exhibited an extremely sharp pore diameter distribution. On the other hand, the titania porous substance of Comparative Example No. 1 had meso-pores as well as macro-pores, and exhibited a broad pore diameter distribution.

Further, as can be seen from FIG. 1, in the titania porous substances of Example Nos. 1 and 2, there appeared a diffraction peak which resulted from θ=about 30.8° (i.e., A lattice spacing equals to 0.29 nm approximately.). The diffraction peak is a second peak which derived from the brookite phase. Note that a first peak, which derived from the brookite phase, is hidden by the anatase-phase diffraction peak. Furthermore, in the titania porous substance of Example No. 1, there appeared peaks at θ=about 42.27°, θ=about 44.38° and θ=about 64.73°. These diffraction peaks derived from the brookite phase. On the contrary, in the titania porous substance of Comparative Example No. 1, there appeared no diffraction peak which derived from the brookite phase.

Moreover, in the titania porous substances of Example Nos. 1 and 2, a ratio of an intensity of the diffraction peak at θ=about 30.8° with respect to an intensity of the strongest diffraction peak which derived from the anatase phase was calculated, respectively. The results are also summarized in Table 1. As recited in Table 1, the titania porous substance of Example No. 1 exhibited a larger intensity of the diffraction peak at θ=about 30.8° than that of Example No. 2 did. Thus, it is apparent that the brookite phase is more likely to generate when the deposits are calcined as they are without washing them.

### EXAMPLE NO. 3

To a powder of the titania porous substance prepared in Example No. 1, Pt was loaded by impregnation by using a dinitrodiammine platinum nitrate aqueous solution so that the Pt was loaded in an amount of 1 g with respect to 100 g of the titania porous substance. Then, after drying the powder, the powder was calcined in air at 300° C. for 3 hours. Finally, after compacting the powder, the resulting compacted substance was pulverized. Thus, a pelletized catalyst of Example No. 3 was prepared which had a particle diameter of from 0.5 to 1.0 mm.

### EXAMPLE NO. 4

Except that a powder of the titania porous substance prepared in Example No. 2 was used instead of the titania porous substance prepared in Example No. 1, a pelletized catalyst of Example No. 4 was prepared in the same manner as Example No. 3.

### Comparative Example No. 2

Except that a powder of the titania porous substance used in Comparative Example No. 1 was used instead of the titania porous substance prepared in Example No. 1, a pelletized catalyst of Comparative Example No. 2 was prepared in the same manner as Example No. 3.

### Comparative Example No. 3

Except that a commercially available γ-alumina powder was used instead of the titania porous substance prepared in Example No. 1, a pelletized catalyst of Comparative Example No. 3 was prepared in the same manner as Example No. 3. The commercially available γ-alumina powder was produced by W. R. Grace Co., Ltd., and exhibited a BET specific surface area of 220 m²/g.

### Comparative Example No. 4

A commercially available Cu—Zn-based catalyst was pulverized to use. The commercially available Cu—Zr-based catalyst was produced by Toyo CCI Co., Ltd., and had a pelletized shape having an average particle diameter of 6 mm.

### Examination and Evaluation

### Effect on Noble Metal

Regarding the catalysts of Example Nos. 3 and 4 as well as Comparative Example No. 2, a CO adsorption and a particle diameter of the Pt, being calculated from the CO adsorption value, were measured, respectively. The results are set forth in the column of Table 3, designated at “I.,” as their initial values.

Moreover, the catalysts of Example Nos. 3 and 4 as well as Comparative Example No. 2 were disposed in a testing apparatus, respectively, and were subjected to a durability test. In the durability test, the respective catalyst was subjected to an inlet-gas temperature of 700° C. for 5 hours while alternately switching the flows of a fuel-lean gas and a fuel-rich gas, recited in Table 2. Note that the fuel-lean gas was flowed for 4 minutes, and the fuel-rich gas was flowed for 1 minute. After the durability test, a CO adsorption and a particle diameter of the Pt were measured, respectively. The results are set forth in the column of Table 3, designated at “A. D. T.,” as their post-durability-test values.

TABLE 2

| | O₂ | NO | C₃H₆ | CO | H₂ | CO₂ | H₂O | |
|---|---|---|---|---|---|---|---|---|
| | (%) | (%) | (ppm) | (%) | (%) | (%) | (%) | N₂ |
| Fuel-lean | 7.0 | 0.15 | 670 | 0.06 | 0.02 | 8.8 | 3 | Balance |
| Gas | | | | | | | | |
| Fuel-rich | 0.2 | 0.15 | 670 | 0.66 | 0.22 | 8.8 | 3 | Balance |
| Gas | | | | | | | | |

TABLE 3

| | |
|---|---|
| Co Adsorption (μmol/g) | Particle Dia. of Pt (nm) |

| | I. (*1) | A.D.T. (*2) | I. (*1) | A.D.T. (*2) |
|---|---|---|---|---|
| Ex. #3 | 43.0 | 2.35 | 0.58 | 10.6 |
| Ex. #4 | 40.9 | 2.12 | 0.61 | 11.7 |
| Comp. Ex. #2 | 34.4 | 0.49 | 0.72 | 50.8 |

Note:
(*1) means “Initial.”
(*2) means “After Durability Test.”

It is understood from Table 3 that the catalysts of Example Nos. 3 and 4 exhibited a smaller Pt particle diameter and a higher CO adsorption than the catalyst of Comparative Example No. 2 did. Thus, it is believed that, in the catalysts of Example Nos. 3 and 4, the Pt was loaded stably as well as in a highly dispersed manner because the Pt was loaded in the meso-pores of the titania supports, which were made from the titania porous substances of Example Nos. 1 and 2 exhibiting the sharp pore diameter distribution and including the brookite phase. Moreover, after the durability test, the extent of deterioration was less in the catalysts of Example Nos. 3 and 4 than in the catalyst of Comparative Example No. 2. Hence, it is appreciated that the catalysts of Example Nos. 3 and 4 exhibited a high durability after they were subjected to a high temperature.

### Effect on H₂O Adsorption

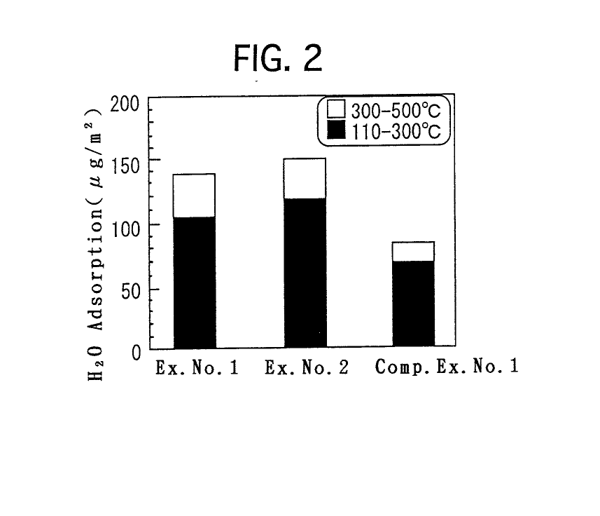

The titania porous substances of Example Nos. 1 and 2 as well as Comparative Example No. 1 were disposed in a thermogravimetric analyzer. A weight reduction of the respective titania porous substances was measured while supplying a nitrogen gas and increasing the temperature. Note that the nitrogen gas included H₂O in an amount of 3% by volume, and that the temperature was increased at a rate of 10° C./min. An H₂O adsorption onto the respective titania porous supports was calculated from the results of the thermogravimetric analysis. FIG. 2 illustrates the results of the examination.

It is seen from FIG. 2 that the titania porous supports of Example Nos. 1 and 2 exhibited a greater H₂O adsorption than that of Comparative Example No. 1 did, and that they exhibited a large H₂O adsorption in a temperature range of from 110 to 300° C. which is utilized in the CO shift reaction. Therefore, the titania porous supports of Example Nos. 1 and 2 are expected to facilitate the CO shift reaction, and the like, in which H₂O is a reactant.

### Effect on CO Adsorption Force

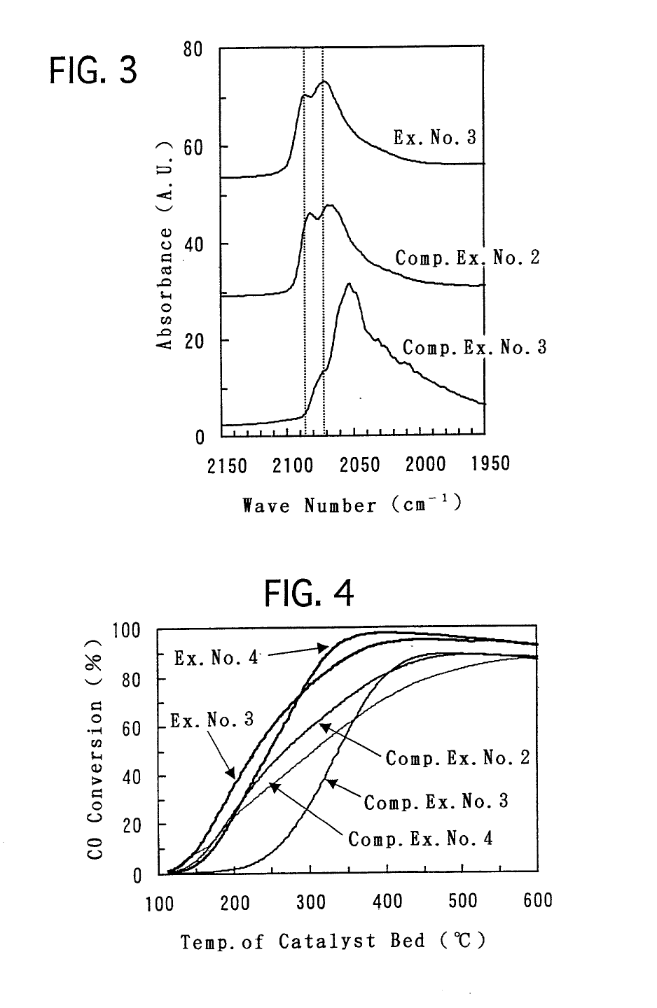

A nitrogen gas was supplied to the catalysts of Example No. 3 as well as Comparative Example Nos. 2 and 3. Note that the nitrogen gas included CO in an amount of 0.4% by volume. Thereafter, an IR (i.e., Infrared Radiation) spectrum of CO, which was adsorbed onto the respective catalysts, was measured with an FT-IR (i.e., Fourier Transformer-Infrared Radiation) spectrometer. FIG. 3 illustrates the results of the measurement. In the IR spectrum of adsorbed CO, it has been known that the weaker the adsorption force between Pt and CO is, on the higher wave number side, the peak appears.

FIG. 3 shows the following. The peak of CO, which was adsorbed onto the catalyst of Example No. 3, appeared on a remarkably higher wave number side than the peak of CO, which was adsorbed onto the catalyst of Comparative Example No. 3, did. It even appeared on a higher frequency side than the peak of CO, which was adsorbed onto the catalyst of Comparative Example No. 2, did. Namely, the Pt, which was loaded on the titania porous support of Example No. 3 having the meso-pores whose pore diameter distribution was sharp, exerted a weaker adsorption force to CO than the Pt, which was loaded on the titania porous support of Comparative Example No. 2 exhibiting a broad pore diameter distribution, as well as the Pt, which was loaded on the alumina, did. Therefore, in accordance with the catalyst of Example No. 3, it is expected to relieve the self-poisoning by CO in the reactions, such as the CO shift reaction and the CO oxidation reaction, in which CO is a reactant, and to facilitate the reactions in a low temperature range.

### Effect on CO Shift Reactivity

The catalysts of Example Nos. 3 and 4 as well as Comparative Example Nos. 2 through 4 were disposed in an ordinary-temperature fixed-bed flow type reactor. As a preliminary treatment, the catalysts were heated at 500° C. for 15 minutes while supplying a model gas. Note that the model gas comprised 1.8% by volume of CO, 10% by volume of H₂O and the balance of N₂. Thereafter, the catalysts were cooled to 100° C. Subsequently, the catalysts were heated from 100° C. to 700° C. at a rate of 15° C./min. while supplying the same model gas. In this instance, CO concentrations in the catalyst-outlet gases were measured with a non-dispersing infrared radiation type Co analyzer. Note that the space velocity was 200,000 hr⁻¹ approximately in the measurement. Then, Co conversions were calculated at the respective temperatures. The results are illustrated in FIG. 4.

It is seen from FIG. 4 that the catalysts of Example Nos. 3 and 4 exhibited a higher CO shift reactivity in a low temperature region than the catalysts of Comparative Example Nos. 2 and 3 did. It is also apparent that the catalysts of Example Nos. 3 and 4 exhibited a higher CO shift reactivity than the CO shift reaction catalyst of Comparative Example No. 4, which is used widely in industrial fields, did.

Having now fully described the present invention, it will be apparent to one of ordinary skill in the art that many changes and modifications can be made thereto without departing from the spirit or scope of the present invention as set forth herein including the appended claims.

What is claimed is:

1. A titania-based porous substance being a porous substance comprising titania as a principal ingredient and exhibiting an x-ray diffraction peak resulting from lattice planes whose spacing falls in a range of 0.290±0.002 nm.

2. The titania-based porous substance according to claim 1 further exhibiting x-ray diffraction peaks resulting from lattice planes whose spacing falls in a range of 0.213±0.002 nm and lattice planes whose spacing falls in a range of 0.144±0.002 nm.

3. The titania-based porous substance according to claim 1, wherein said x-ray diffraction peak exhibits an intensity of 0.1% or more of an intensity of the strongest diffraction peak which derives from the anatase phase.

4. The titania-based porous substance according to claim 1, wherein said x-ray diffraction peak derives from the brookite phase.

5. A titania-based porous substance being a porous substance comprising titania as a principal ingredient and having a median pore diameter which falls in a meso-pore range of from 3 to 100 nm.

6. The titania-based porous substance according to claim 5, wherein 50% or more of the summed volume of pores, whose pore diameters fall in the meso-pore range, occupies the summed volume of pores, whose pore diameters fall within a range of ±5 nm of said median pore diameter.

7. The titania-based porous substance according to claim 5, wherein 40% or more of the summed volume of pores, whose pore diameters fall in the meso-pore range, occupies the summed volume of pores, whose pore diameters fall within a range of ±3 nm of said median pore diameter.

8. A CO shift catalyst in which the titania-based porous substance set forth in claim 1 makes a support.

9. A CO shift catalyst in which the titania-based porous substance set forth in claim 5 makes a support.

10. A catalyst in which a noble metal is loaded on the titania-based porous substance set forth in claim 1.

11. The catalyst according to claim 10, wherein said noble metal includes platinum at least.

12. A catalyst in which a noble metal is loaded on the titania-based porous substance set forth in claim 5.

13. The catalyst according to claim 12, wherein said noble metal includes platinum at least.
